(19) United States
(12) Patent Application Publication
(10) Pub. No.: US 2024/0204206 A1
(43) Pub. Date: Jun. 20, 2024

(54) Electrode

(71) Applicant: BAUMGARTNER & LAMPERSTORFER INSTRUMENTS GMBH, Feldkirchen (DE)

(72) Inventors: Michael LANGE, Feldkirchen (DE); Martin FORSTNER, Feldkirchen (DE); Robert BAUMGARTNER, Feldkirchen (DE)

(21) Appl. No.: 18/294,898

(22) PCT Filed: Jul. 6, 2022
(86) PCT No.: PCT/EP2022/068779

§ 371 Date: Feb. 2, 2024

(30) Foreign Application Priority Data
Jul. 8, 2021 (DE) 102021117722.7

(51) Int. Cl. H01M 4/74; H01M 4/02; H01M 4/04; H01M 4/80

(52) U.S. Cl. CPC H01M 4/747; H01M 4/0404; H01M 4/801; H01M 2004/021; H01M 2004/029

(57) ABSTRACT

Baumgartner & Lamperstorfer Instruments GmbH B10930PWO-R/To 45 Abstract A highly efficient electrode, especially but not exclusively for an electrolyser for the generation of hydrogen, includes at least an electrically conductive plate, at least one layer of an electrically conductive mesh having knuckles in fused 5 electrical contact with the electrically conductive plate and mesh passages for the flow of an electrically conductive medium laterally through the mesh, as well as a porous layer of electrically conductive material coating a surface of the at least one layer of electrically conductive mesh remote from the conductive plate. The porous layer is in fused electrical contact with the mesh and has a planar surface 10 remote from the electrically conductive plate. A pore size of the porous layer is substantially smaller than a pore size of the mesh passages. 15.

The present invention relates to an electrode with general utility and to an electrode specifically adapted for use in an electrolyser of the type using an anionic exchange membrane. Electrodes of the type described here can be used in electrolysers of all kinds, in fuel cells, in batteries and in catalysers such as reformers.

Known types of electrolysers frequently comprise a stack formed by an anode, one or more bipolar plates and a cathode with nickel based porous electrode layers arranged in pairs between the anode and a first bipolar plate, between the first bipolar plate and further bipolar plates and between the last bipolar plate and a cathode. Anionic exchange membranes are provided between each pair of porous electrode layers. The porous electrode layers usually comprise two or three calendered sheets of porous nickel foam, with the sizes of the pores being largest in the sheet adjacent the plates and smallest adjacent the anionic exchange membranes.

In operation the stack of plates and electrodes is pressed together and a potential difference is applied between the anode and the cathode while water with an addition of a conductive material such as an alkali metal hydroxide, especially KOH, is pumped through anode spaces formed at the anode side of each membrane. The electric field generated between the anode and the cathode results in the bipolar plates adopting floating potentials, so that one side of each bipolar plate acts as an anode and the other side as a cathode. Water and O₂ are extracted from the porous electrode on the anode side of the anionic membrane and H₂ and OH from the cathodic side of the membranes.

In practise several disadvantages arise with this system. Firstly the electrical contact resistances between the porous electrode layers and between the plates and the adjacent porous layers are difficult to control, have a non-uniform distribution and also lead to resistances that are too high for the economic generation of hydrogen. Moreover, it is difficult to control the porosity of the individual porous layers so that a non-uniform porosity distribution exists in the stack. This is also unfavourable for the economic generation of hydrogen by electrolysis.

In addition electrolyser stacks of the described kind require the use of very pure, twice distilled water and the cost of generating such twice distilled water is very high, which again significantly increases the cost of generating hydrogen by electrolysis.

The principle object of the present invention is to provide an electrode and an electrode stack, as well as methods of generating electrodes and electrode stacks which, while being of general utility in electrolysis, fuel cells and batteries, are particularly suited to the economical generation of hydrogen by electrolysis, which do not suffer from high electrical resistance or non-uniform electrical resistance or porosity and which preferably do not require the use of twice distilled water. At this stage reference should also be made to the document DE 10 2018 132 399 A1 which discloses an electrolyser having a cell or cells each with a central proton exchange membrane, a thin noble metal electrode on either side of the membrane and gas diffusion bodies on the sides of the electrodes remote from the membrane.

Each gas diffusion body consists of at least one base layer of an electrically conductive expanded metal grid or electrically conductive grid or fabric and at least one additional layer formed by a thermal spray process by spraying electrically conductive particles.

If plural layers are used for the base layer to form a base layer assembly then these are said to be rolled, soldered or welded together. No material is named for such a base layer or layers. The at least one additional layer is said to be of titanium with admixed additives of platinum, gold and or indium to increase the oxidation resistance,

The porosity of the base layer(s) and the at least one additional layer reduces in the direction towards the noble metal electrodes. The need to use noble metals for the electrodes and for the particles of the at least one additional layer makes the design very expensive. Moreover, the need to use thermal spraying is very disadvantageous because during thermal spraying the particles melt and flatten on impact, thus forming a layer with overlapping scales of welded together flattened particles which may be porous but has a very high flow resistance to lateral flow. Moreover many of the pores are closed pores rather than open or interconnected pores so that flow through them is not possible. Furthermore, there is an ill-defined and not easily controlled electrical resistance of the gas diffusion bodies and between the gas diffusion bodies and the thin electrodes contacting them. The cell operates with fully de-ionized water.

The reference mentions the use of sinter bodies made by ejecting a paste of particles with a solvent and a binder through a slit nozzle onto a foil and subsequently drying it and sintering it to form a sintered body, so called foil casting. However, the document describes this process as being complicated and resulting in porous bodies of low mechanical stability and with extreme shrinkage problems following removal from the sintering oven. The precise design of the stack is not disclosed, far less the way in which oxygen and hydrogen are extracted from the cell.

For the sake of completeness reference should also be made here to the document DE 10 2020 111436A which was published after the claimed priority date. This document relates to a gas diffusion layer for an electrolyser having gas passages which extend from the front side of the layer to the rear side thereof which are directed primarily axially transverse to the front side of the layer and especially perpendicular thereto and at least one support layer formed by a metal foil having three dimensional structuring. In one embodiment the support layer comprises a plurality of parallel wires fixed together in one layer or in two layers which may be skewed relative to one another. The straight wires of circular cross-section form funnel shaped passages and the grooves at the front side of the support layer are filed with porous granulate material. The use of straight wires to which the granulate is sintered has the disadvantage that the sintered material tends to crack during shrinkage following sintering. This does not occur with the electrodes of the present teaching due to the use of woven or knitted meshes, which is not suggested in the reference, but which have loops or curved reigns which can better accommodate shrinkage during sintering.

In comparison to the two proposals discussed immediately above the object of the present invention is to provide an electrode which does not require noble metals, has a high mechanical stability and resistance to cracking, has a low electrical resistance, has uniform properties across the area of the cell, has good lateral flow properties for an electrolyte and a straightforward design, with repeatable and controllable properties for use in stacks with multiple cells as well as a high conversion efficiency for converting an electrolyte consisting of water and a conductive salt into hydrogen and oxygen.

In order to satisfy this object there is provided, in accordance with the present invention, an electrode including at least an electrically conductive plate, at least one layer of an electrically conductive mesh having knuckles in fused electrical contact with the electrically conductive plate and mesh passages for the flow of an electrically conductive medium laterally through the mesh, as well as a porous layer of electrically conductive material coating a surface of the at least one layer of electrically conductive mesh remote from the conductive plate, in fused electrical contact therewith and having a planar surface remote from the electrically conductive plate, a pore size of the porous layer being substantially smaller than a pore size of said mesh passages.

An electrode of this kind, which can be used as an anode or cathode, is conveniently made by a method including the steps of:
a) introducing a slurry of particles in a hardenable and reducible binder medium into a mould having a planar base surface,
b) placing a layer of an electrically conductive mesh having knuckles onto the first layer and coating the knuckles with said slurry,
c) placing a metal plate onto knuckles of said mesh remote from said slurry,
d) partially hardening or fully hardening said binder medium prior to or after step c) and
e) heating the electrode in a reducing atmosphere to remove the binder medium and sinter the electrode assembly together.

For an electrode for use in an electrolyser for the generation of hydrogen the conductive plate, the at least one layer of electrically conductive mesh and the electrically conductive particles coating the mesh and present in the porous layer are all preferably of nickel, although other materials such as copper, gold, carbon or platinum could be considered.

Because the layer of electrically conductive mesh is sintered and thus fused to the sintered together metal particles and to the conductive metal plate at the regularly distributed knuckles of the mesh, there is an excellent and uniform electrical contact and low resistance between the porous layer and the plate. Also the planar surface of the porous layer, the quality of which is determined by the quality of the planar surface of the mould, has excellent conformity and contact to the anionic exchange membrane. Since the porous layer adjacent the anionic membrane has a high and a uniform degree of porosity, i.e. a very high number of very small pores, typically of the order of one micron in size, the movement of the oxygen ions through the porous layer into the at least one layer of conductive mesh is facilitated. The pores of the porous layer are open pores, i.e. they communicate with one another to enable flow through the porous layer.

One problem that can occur with a design of the above referenced kind is that the shrinkage of the porous layer during sintering can cause cracking of the conductive mesh. If this is a problem several solutions are possible. One is to use a woven or knitted mesh with mesh loops which are shaped to tolerate or accommodate the shrinkage of the porous layer. Another solution is to use not just one layer of mesh but rather first and second layers. The layer adjacent to the porous layer can be a relatively fine weave or knit with smaller wire size and smaller mesh passages which is more resistant to cracking, whereas the layer adjacent to it and to the conductive metal plate can be a coarser weave or knit with larger mesh passages. In such a design the first and second layers are sintered together at their points of contact. When the mesh is of a coarser weave the permeability of the mesh for the lateral flow of electrolyte is higher and there is less flow resistance.

Thus, in such an electrode, said at least one layer of an electrically conductive mesh comprises first and second layers of an electrically conductive mesh, the first layer being in fused electrical contact with the porous layer and having first mesh passages and the second layer of an electrically conductive mesh has second mesh passages larger than said first mesh passages, the second layer being in fused electrical contact with the first layer and with said electrically conductive plate. That is to say a pore size of the mesh passages of the first layer of mesh is typically smaller than a pore size of the mesh passages of the second layer of mesh.

Moreover, since the first and second layers of the mesh are sintered together at points at which they contact each other, and at points at which nickel particles of the porous layer are sintered to the first layers, there is a good “fused” electrical contact between the first and second layers as well as between the conductive plate and the particles of the porous layer. The word “fused” as used herein will be understood to mean a continuous metal transition from one component of the electrode to the next, rather than a simple physical contact.

Thus, an electrode of this kind, which can be used as an anode or a cathode at either end of a stack, is ideally suited for use in an electrolyser.

Moreover, using a similar technique or layout it is readily possible to develop further electrodes with the same beneficial properties on both sides of a so called bipolar plate. The name “bipolar plate” arises because an electrode plate between two neighbouring electrodes acts as an anode for one cell and as a cathode for the neighbouring cell.

In order to generate such a bipolar plate and electrode assembly one first starts, in accordance with the present invention, with an electrode of the initially described kind in accordance with the invention and provides, at a surface of said electrically conductive plate remote from said first layer, an electrical contact with knuckles of a third layer of electrically conductive mesh having a pore size of the mesh passages and a permeability comparable to that of said second layer, said third layer optionally being in electrical contact with a further porous layer, either directly or indirectly via a fourth layer of an electrically conductive mesh having a pore size of the mesh passages and a permeability comparable to that of said first layer, the further porous layer having a planar surface remote from the electrically conductive plate and a pore size smaller than a pore size of mesh passages of the third layer, or if provided of the fourth layer. Again the pores of the further porous layer are open pores permitting flow through the further porous layer.

Thus, the electrodes at the cathode and anode sides of each bipolar plate can be substantially identical or simpler at the cathode side if a fourth layer of mesh is not provided. A simpler design of the electrode components at the cathode side of each cell is possible because there is no actively pumped flow of electrolyte through the cathode spaces. Instead these are simply moist with electrolyte which is perfectly adequate to allow ions, for example KOH ions, to split into K atoms and OH-ions at the cathode side of each bipolar plate. The K atoms (potassium atoms) react at the cathode plate and at the cathode side of each bipolar plate with water in the electrolyte to generate hydrogen which then escapes laterally through the cathode space to an outlet.

A bipolar plate of this kind can be manufactured in accordance with the present invention by a method of the initially named kind and comprising the further steps of:
g) repeating the steps a), b) c) and d),
h) inverting the resulting electrode assembly
i) repeating the steps and a) and b),
j) placing the inverted electrode assembly of step h) on the assembly resulting from the repeated steps a) and b) and carrying out or repeating the steps d) and e).

There are various possibilities of realising the electrically conductive mesh of any of the first, second, third and fourth layers. For example, any one of said layers can be one of a woven wire mesh, a knitted wire mesh and an expanded metal grid. In theory any known type of weave such as a plain weave can be used for the meshes and can, if desired, be calendered prior to incorporation into an electrode to provide flat knuckles leading to an improved contact with a neighbouring plate, with a neighbouring layer of mesh and/or with a porous layer of a conductive medium. A particularly preferred weave, especially for the mesh having larger mesh passages, is a so-called five shaft Atlas weave available from the company GKD Gebr. Kufferadt AG, Metallweberstraße 46, 52353 Düren, Germany under the article number 16370260. This weave has a mesh width of 0.795 mm×1,064 mm and a mesh opening of 1027 microns. For this the wire diameter of both the weft and warp wies is 0,900 mm. GKD normally supply this weave using a stainless steel wire, however for an electrolyser a nickel wire is preferred. For the finer mesh, for example for the first layer, a square mesh in accordance with DIN ISO 9044 can be used with a 2/2 binding. This mesh is available from GKD using a stainless steel wire under the designation 10371575. Instead of the stainless steel wire used for the weave supplied under this article number by GKD it is necessary to use a nickel wire for the warp and weft wires of 0.26 mm diameter in a 60 mesh weave with mesh openings of 0,163 mm. Another alternative for the finer mesh is a square mesh weave of the same kind (also available from GKD in a 60 mesh) but with a mesh width of 0,173 mm with the warp and weft threads each having a wire diameter of 0.25 mm. GKD sell tis fabric in a pure nickel wire as Article10231568.

GKD's website lists a variety of weaves that can potentially be adopted for use in the present invention and lists pore sizes for individual weaves. However, the applications quoted for the individual weaves are primarily for use as filters and the pore sizes listed correspond to the size of particles that are filtered out by the individual weaves. The pore size that is of interest for the present invention is, however, the pore size of the individual weaves for flow laterally through the mesh. The idea here is not to filter the flow but to achieve adequate lateral flow permeability. In a weave there will invariably be two sequential weft threads that cross one another from opposite sides of a warp thread forming a weft passage in the warp direction having an approximately V-shaped cross-section. The maximum size of a sphere which will pass along such a weft passage is regarded herein as the pore size of the weave for lateral flow through the weave. It is generally the same as or slightly smaller than the cross sectional size of the warp threads that are used. Such a pore size concept is in line with the definition given on GKD's website relating to work done by Stuttgart University.

This does not mean that the weft threads all have to alternate in the sense of coming from opposite sides of a warp thread, i.e. from above and below a warp thread, nor that alternating weft threads have to alternate around each warp thread. For example, for each weft repeat, two or more weft threads could pass in parallel through each weft space between sets of warp threads and two or more warp threads could extend in parallel through the weave for each warp repeat.

The weave chosen can be fabricated from a wire of circular cross-section or from a wire of flattened cross-section or from a wire ribbon having a generally rectangular cross-section. Such wires can be used for either the weft or warp threads or for both.

Also wires of any of the above kind can also be used to advantage in a knitted fabric used as the mesh. As an alternative an expanded metal grid can be used as at least one of the electrically conductive meshes and can also be calendered to provide flat knuckles.

As indicated above good electrical contacts between the plate and the layers of electrically conductive mesh and the porous layer(s) of electrically conductive medium can be achieved by the sintering process.

It is also possible to coat the mesh or meshes that are used and if required also the conductive plates with conductive particles in a binder which is evaporated leading to sintered connections between the various components and the particles during the subsequent sintering process in a reducing atmosphere. The coating must be carried out in such a way, e.g. by spraying or spin coating, that the mesh passages are not unduly obscured. Thus, in an electrode having at least one layer of mesh the at least one layer of mesh can advantageously be coated with sintered particles. This can help the sintering of the at least one layer to an adjacent layer and/or to the conductive plate.

Thus, in an electrode of the above described kind the first and second and, if present, the third and fourth layers of woven or knitted wire mesh can, if desired, be coated at least in part with sintered material.

Moreover, by controlling the particle size ranges of the particles used at different components of an electrode it is possible to control the porosity and the electrical conductivity of the individual layers. Particularly preferred for the sintered material sintered onto the wire meshes and in particular for the porous layer(s) are particle sizes in the range from 0.1 microns to 10 microns. When such particle sizes are used for the porous layer(s) the interstitial spaces or pores resulting after the reduction and removal of the binder and sintering have sizes of approximately one tenth of the sizes of the sintered particles that are used. The pores are open pores. That is to say they communicate with one another thus permitting flow through the porous layer.

In an electrode of the above named kind for use in the electrolysis of water to generate hydrogen, the plate, said first and second layers of electrically conductive mesh, if present the third and fourth electrically conductive layers of mesh and said layer or layers of conductive material preferably all comprise nickel. This is an ideal metal for the electrolysis of water to generate hydrogen,

In a particularly preferred design the porous layer comprises metal particles having sizes in the range from <0.1 microns to 10 microns, preferably from <1 micron to<5 microns and especially in the range from 1 to 2 microns

In contrast the mesh passages of said at least one layer of mesh have pore sizes for lateral flow through the mesh in the range from 20 microns to 2 mm, preferably in the range from 50 microns to 1 mm and especially of the order of 100 to 200 microns.

If first and second layers of wire mesh are used the first layer of mesh adjacent the conductive plate preferably has mesh passages having a pore size for lateral flow larger than those of the mesh adjacent the porous layer, the pores of the mesh adjacent the porous layer having pore sizes for lateral flow through the mesh in the range from 10 microns to 250 microns, preferably in the range from 50 microns to 150 microns and especially of the order of 100 microns.

The electrode descried above is particularly useful for the anode of each electrolysis cell, However, the structure defined above can readily also be used at a second side the other side of a bipolar plate for the cathode of an adjacent electrolysis cell. It is not essential that the electrode structure used for the cathode is identical to that used for the anode.

In such a design of a bipolar plate a surface of said electrically conductive plate remote from said at least one layer is expediently in electrical contact with knuckles of at least one further layer of electrically conductive mesh having mesh passages, said at least one further layer of mesh being a single layer or first and second layers of mesh and knuckles of said at least one further layer remote from said electrically conductive plate, being in fused electrical contact with a further porous layer of electrically conductive material coating a surface of the at least one further layer remote from the conductive plate, being in electrical contact therewith and having a planar surface remote from aid electrically conductive plate.

Any said layer of mesh can expediently comprises one of a woven wire mesh, a knitted wire mesh and an expanded metal grid. Moreover, for an electrolyser, the conductive plate, any said layer of mesh and said electrically conductive particles forming the or each porous layer preferably comprise any one of nickel, copper, gold, carbon (filaments) or platinum.

All electrical contacts between components of the electrodes are preferably sintered, i.e. fused contacts. This insures the electrical resistance of the electrode assemblies is minimized. Thus all the components of the electrodes form a single body formed by sintering, a sintered together body.

As mentioned above the electrodes in accordance with the invention are preferably combined into an electrode stack comprising a first electrode in accordance with claim 1, a plurality of electrodes in accordance with claim 9 and a further electrode in accordance with claim 1, said electrodes being disposed to generate pairs of confronting planar surfaces of porous material, there being an anionic exchange membrane disposed between each pair of confronting planar surfaces, there being hydraulic, pneumatic or spring means for pressing the electrodes of the stack and the interposed anionic exchange membranes together.

In such a stack first passages are provided for supplying a conductive liquid formed by water with an alkaline metal hydroxide, such as KOH, to anode spaces at an anode side of each anionic membrane and second passages for extracting the conductive liquid with oxygen from the electrodes from the anode spaces, there being at least one third flow passage for extracting hydrogen from cathode spaces at a cathode side of each anionic membrane.

In a preferred design the conductive meshes of the electrodes and the porous layers of the stack are square or rectangular in plan view and are disposed within insulating holders forming manifolds for the anode spaces, there being seals between adjacent holders and the conductive metal plates overlap the holders disposed between them.

In such a stack the holders and the conductive plates are circular or polygonal in plan view. The membranes are preferably square or rectangular but slightly larger than the cathode spaces of the holders so that they sit on and seal against rectangular or square seats surrounding the rectangular or square openings in the holders. In practice the electrodes of the anode spaces are of the same size and shape as the anionic exchange membranes so that they press the anionic exchange membranes against the seats.

Since the holders are preferably circular or possibly polygonal in plan view it is relatively easy to use O-ring seals between adjacent holders with an O-ring seal at one side of each holder being radially offset with respect to the O-ring at the other side of the same holder. Such an arrangement of O-rings makes it possible to effectively seal the stack relative to the electrically conductive plates and against loss of electrolyte. The use of radially offset seals makes it possible to achieve good sealing while minimising the axial thickness of the holders and the electrodes so as to achieve a compact and efficient electrolyser. Moreover, the design also makes it possible to control the degree of compression of the individual electrodes as well as providing well defined and sealed paths for the flows of electrolyte and hydrogen and oxygen within and out of the electrolyser.

The electrical connection to the stack can either take place in the conventional manner, wherein conductive plates at each end of the stack are respectively connectable to one of the anode and cathode of a (DC) power supply. Alternatively, in accordance with a special embodiment of the invention, the two conductive plates at each end of the stack are both connectable to one of the anode and cathode of the power supply and a centre electrode of the stack is connected to the other of said anode or cathode. This arrangement has the special benefit that it largely eliminates external electric fields enhancing the electric field strength in the interior of the electrolyser with attendant advantages. The same advantage also applies to other kinds of stack, such as those found in fuel cells or batteries.

Particularly preferred embodiments of the invention are set forth in claims 13 to 22.

The invention will now be explained in more detail by way of example and with reference to the accompanying schematic drawings illustrating preferred embodiments of the invention. In the drawings there are shown:

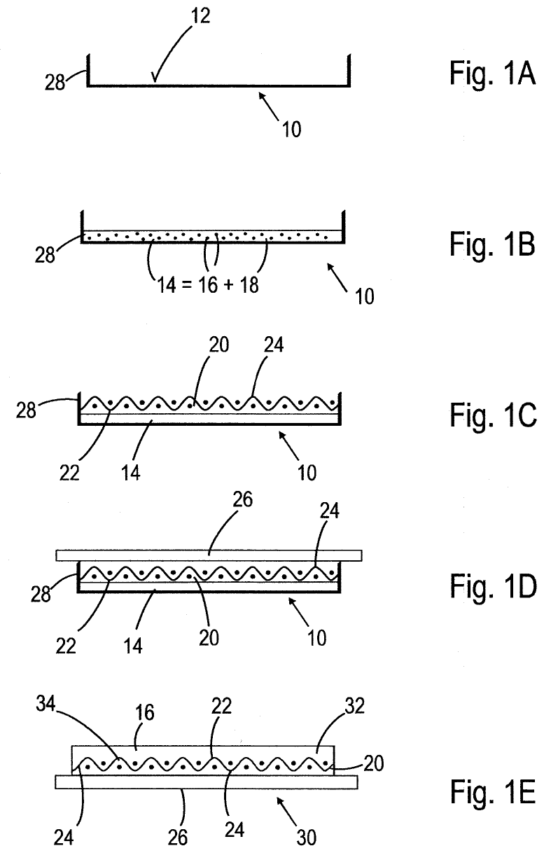

FIGS. 1A to 1E a simplified way of forming a first simple but expedient electrode in accordance with the present invention,

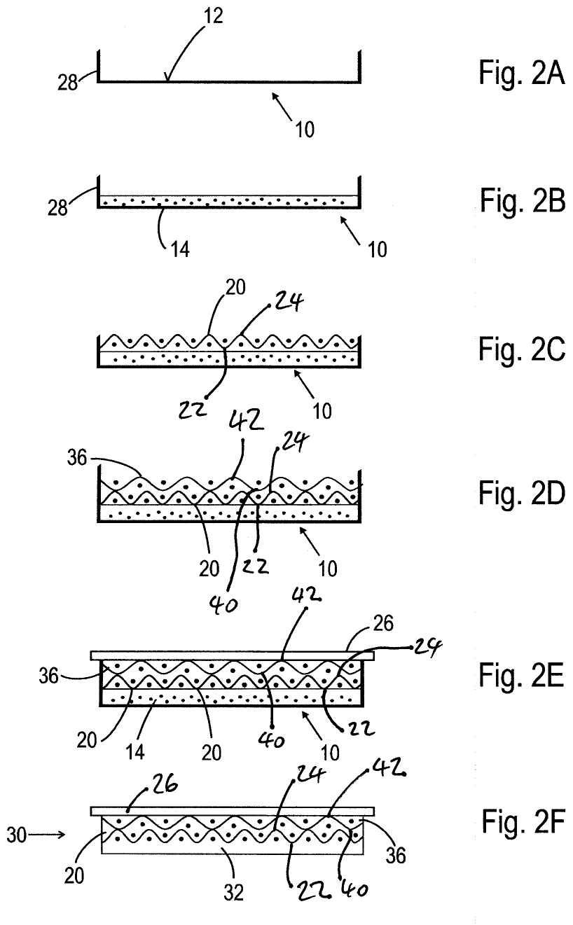

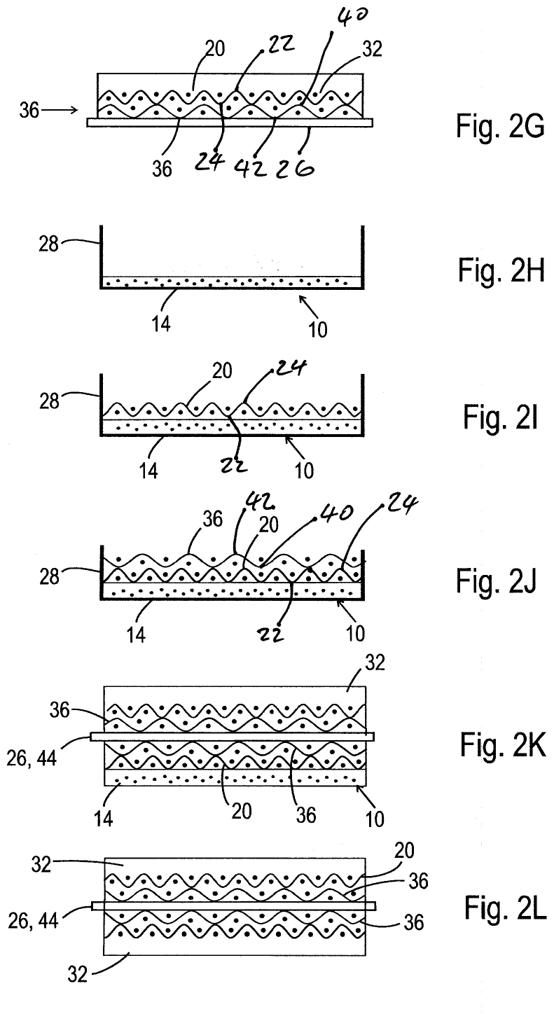

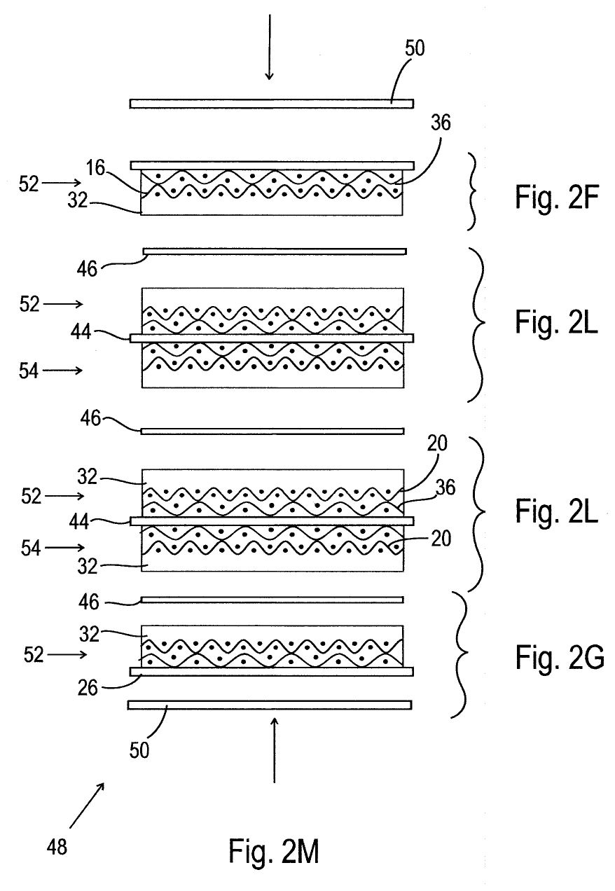

FIGS. 2A to 2M a series of sketches illustrating the preferred way of manufacturing a preferred embodiment of the present invention,

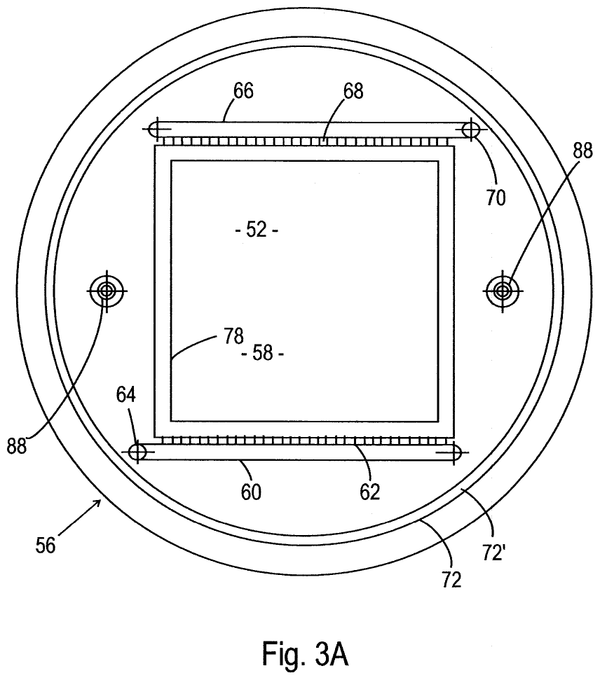

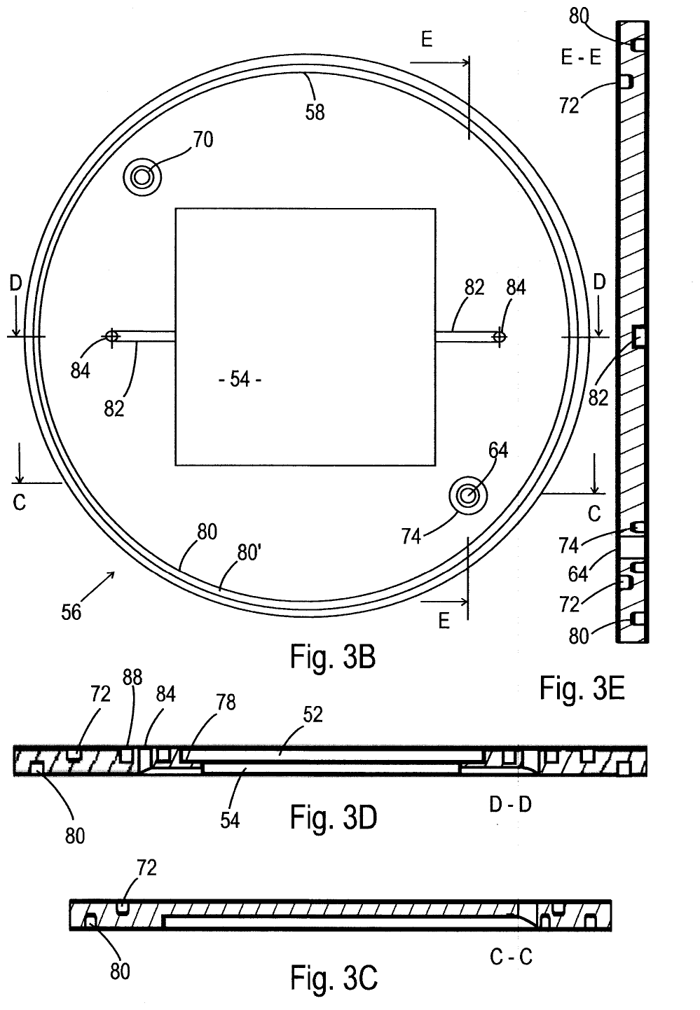

FIGS. 3A to 3E representations of an electrode holder in accordance with the present invention with FIGS. 3C to 3E not being to scale and increased in size in the direction perpendicular to FIGS. 3A and 3B to show the detail more clearly, more specifically

FIG. 3A is a plan view of the abode side of the holder,

FIG. 3B is a plan view of the cathode side of the electrode holder,

FIG. 3C is a section of the electrode holder in the section plane C-C of FIG. 3B

FIG. 3D is a section of the electrode holder on the section plane D-D of FIG. 3B and

FIG. 3E is a section of the electrode holder on the section plane E-E of FIG. 3B and

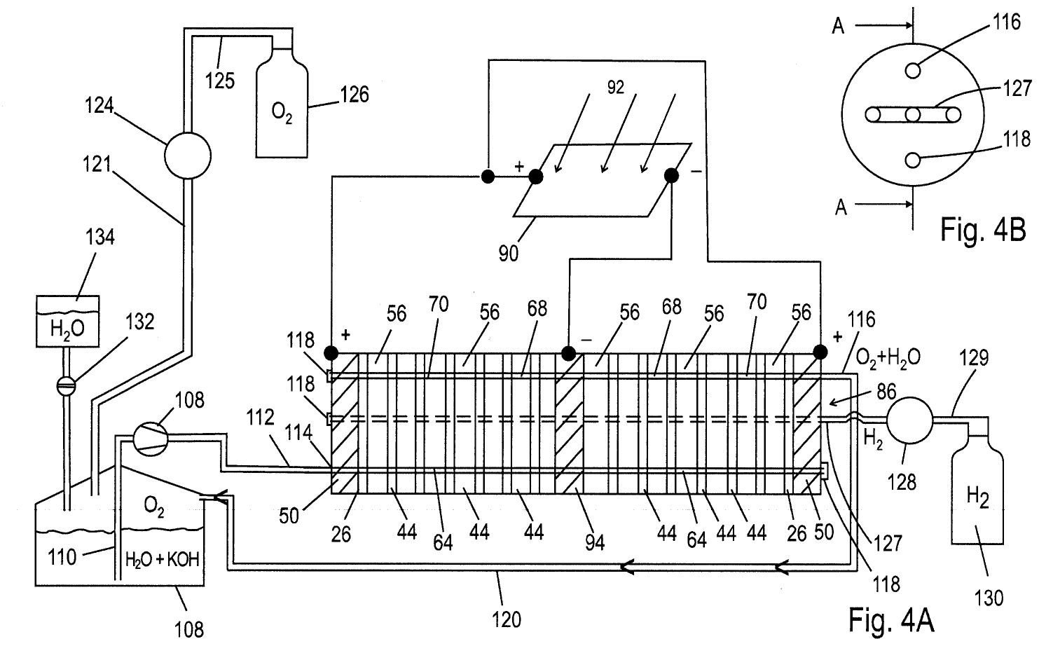

FIG. 4 is a preferred embodiment of the connection of the stack to a DC electrical power supply, which can be formed by solar panels.

FIG. 4A is a highly schematic section of a preferred embodiment of a stack showing the connection of the stack to a DC electrical power supply, which can be formed by solar panels,

FIG. 4B is an end view of the stack of FIG. 4 showing the plane A-A in which the section of FIG. 4A is taken,

Turning first to FIG. 1A there can be seen a schematic diagram of a mould 10 for forming an electrode assembly. The mould 10 has an internal base surface 12 which is planar and preferably polished to a mirror surface. In FIG. 1B a layer 14 comprising a slurry 14 of particles 16 in a binder medium 18 has been introduced into the mould 10 and been vibrated and/or subjected to a vacuum to extract air bubbles from the slurry and generate a homogenous layer.

The particles 16 can for example be nickel particles with a size in the range from <0.1 microns to 10 microns. The binder medium 18 can, for example, be an epoxy resin or a sugar or an organic polymer. In principle any binder medium can be used provided it is capable of being hardened or cured and removed by heating and evaporation or by reduction by a reducing gas such as hydrogen.

If required to ensure clean separation of the partially cured or hardened layer 14 at a later stage, it is possible to treat the mirror surface at the internal base surface 12 of the mould with a release agent (not shown) or to place a layer of a release material (also not shown) such as a plastic film of polyethylene or the like or a wax paper on the base surface 12.

The binder medium 18 can be partially cured or hardened so that it is still soft. As can be seen in FIG. 1C a layer of an electrically conductive mesh 20 having lower knuckles 22 is then placed onto the first layer 14 so that the knuckles 22 are wetted by the slurry 14 and the knuckles 22 are coated with the slurry 14. If desired the mesh 20 can first be rolled or calandered to flatten both the lower knuckles 22 and the upper knuckles 24.

Following this step, as seen in FIG. 1D a conductive metal plate 26 which overlaps the side walls 28 of the mould 10 is placed onto the upper knuckles 24 of the mesh 20 remote from said slurry. If desired a downward force can be exerted on the top of the metal plate 26 to ensure contact with the side walls 28 and the upper knuckles 24. The height of the side walls 28 then controls the thickness of the resulting assembly.

If desired the mesh 20 can previously be coated with a binder medium, or binder medium containing particles so that the upper knuckles are bonded to the metal plate.

Thereafter, the binder medium can be partially hardened or fully hardened and, as illustrated in FIG. 1D removed from the mould to produce a first electrode assembly 30. In FIG. 1E the first electrode assembly 30 is inverted relative to FIG. 1D. Also in FIG. 1E the electrode assembly 30 has been fully cured and sintered in a reducing atmosphere such as hydrogen gas in an oven under pressure to remove the binder medium and to sinter the components together. The sintering is preferably so-called pressureless sintering which is carried out in an oven with a hydrogen atmosphere at a low pressure above atmospheric pressure of about 20 millibar fixed by a non-return valve which vents the gas from the oven to atmosphere where it can simply be burned. It can be helpful to use a weight to apply a compressive pressure to the electrode components during sintering. For example a weight of 10KG for an electrode of 80 mm×80 mm area. The weight or rather the interface between the weight and the electrode assembly should be selected of a material which does not sinter to the electrode, e.g. a ceramic material. The sintering should be carried out at the lowest possible temperature to avoid unnecessary reduction in size of the pores. That is to say the porous layer 32 formed from the layer of slurry 14 (now a sintered layer of metal particles), the layer of mesh 20 and the conductive metal plate 26 are sintered into the finished, fused, first electrode assembly 30, a sintered together body.

This finished assembly 30 can be used in its own right as an anode or as a cathode and could, if desired, also be coated with a catalyst to form a catalytic converter.

The method described above thus results, as shown in FIG. 1E, in a first electrode 30 including at least an electrically conductive plate 26, at least one layer of an electrically conductive mesh 20 having knuckles 24 in fused electrical contact with the electrically conductive plate 26 and mesh passages 34 for the flow of an electrically conductive medium laterally through the mesh 20. The electrode 30 also includes the porous layer 32 of electrically conductive material coating a surface of the at least one layer of electrically conductive mesh 20 remote from the conductive plate 26, in fused electrical contact therewith and having a planar surface remote from the electrically conductive plate 26. A pore size of the porous layer 30 is substantially smaller than a pore size of the mesh passages 34. It should be noted that the surface of the porous layer 32 remote from the conductive plate is planar after sintering but not actually smooth. Instead it has a roughness defined by the size of the sintered particles and the sizes of the open pores or interstitial spaces between the particles. This is actually very advantageous, it enhances the surface area of the porous layer in contact with the anionic exchange membrane which enhances the anionic exchange process. Moreover the resulting surface roughness is fine but regular which enhances the performance of the cell and ensures it is uniform across the full area of the cell, which maximises the cell output. The surface roughness also effectively increases the accessible surface area of the anionic exchange membrane which favours the flow of anions through the anionic exchange membrane.

An electrode assembly 30 as described above can be perfectly satisfactory. However, a problem sometimes arises that the layer of conductive mesh 20 tears or cracks during the sintering process. One way of avoiding this is to use first and second layers of an electrically conductive mesh 20, 36 as indicated in the method described with reference to FIGS. 2A to 2F. As seen in FIG. 2F the lower knuckles 22 of the first layer 20 is in fused electrical contact with the porous layer 32 and has first mesh passages 34 permitting lateral flow through the mesh 20. The second layer of an electrically conductive mesh 36 has lower knuckles 40 with second mesh passages 38 larger than said first mesh passages 34. The second layer 36 has upper knuckles 42 in fused electrical contact with the metal plate 26. In this way the first layer of mesh 20 can be made thinner by the use of finer wire and is thus finer than the second layer 36. This significantly reduces the danger of tearing or cracking of the first layer 20. The first and second layers of mesh are sintered together at points at which upper knuckles 24 of the first layer contact lower knuckles 40 of the second layer 36. It should be noted that both the weft threads and the warp threads of the two layers 20, 36 have upper and lower knuckles. Also, because the first layer of mesh 20 is finer than the second layer of mesh 36 there can be some knuckles of the first layer 20 which do not directly confront knuckles 40 of the second layer 36 so that there are not necessarily fused contacts of all knuckles 24 of the first layer to knuckles 40 of the second layer but there will be many fused contacts between knuckles 24 and adjacent knuckles 40, particularly if the wires of the two layers are wetted with slurry prior to sintering. Because the meshes 20, 36 are regularly repeating weaves there will be a uniform distribution of properties of the electrode across its area.

The way in which an electrode of this kind is manufactured will now be described with reference to FIGS. 2A to 2F. In these figures the same reference numerals will be used as in FIGS. 1A to 1E for components having the same or similar function and the description used for components in FIGS. 1A to 1E will also be understood to apply for the components of the embodiment of FIGS. 2A to 2F, unless something is stated to the contrary. This convention will also apply to the description of all other components of the subsequent figures for components identified by common reference numerals. That is to say the function and arrangement of components identified by common reference numerals will be understood to be the same, unless something to the contrary is stated, in order to simplify the further description.

As can be seen from FIGS. 2A to 2C the steps shown there are largely identical to the steps of FIGS. 1A to 1C. Thus the mould 10 of FIG. 2A is largely identical to the mould 10 of FIG. 1A except that the side walls 28 are rather taller. FIG. 2B again shows the layer of slurry 14, which is the same as the layer 14 of slurry of FIG. 1B. FIG. 2C also shows a layer of electrically conductive mesh here identified with the reference numeral 20 which has lower knuckles 22 in contact with the layer 14 of slurry. The only difference relative to FIG. 1C is that the mesh 20 is a finer weave of a finer wire and less thick than the weave of the mesh 20 of FIG. 1C (although this is not apparent from a comparison of FIGS. 1C and 2C in order to avoid unnecessarily complicating the drawings). The mesh passages 34 for lateral flow through the mesh thus have a smaller pore size relative to those of the mesh 20 in FIG. 1C.

In FIG. 2D the second layer of electrically conductive mesh 36 has been placed with at least some of its lower knuckles 40 in contact with at least some of the upper knuckles 24 of the conductive mesh 20. In FIG. 2E the conductive plate 26 is placed on top of the upper knuckles 42 of the second layer of mesh 36. Once the binder has been cured or fully hardened the electrode assembly of FIG. 2E can then be released from the mould and heated in an oven to evaporate or reduce the binder and to sinter the components together. Thus the upper knuckles 42 of the second layer of mesh are sintered to the conductive plate 26, the lower knuckles 40 of the second layer of mesh 36 are sintered to the upper knuckles 24 of the first layer of mesh 20 and the lower knuckles of the first layer of mesh are sintered to the porous layer 30. Also, as in other embodiments, the weft and warp threads of each layer of woven mesh are sintered together at their points of contact.

If necessary the wefts and warps of each layer of mesh can also be coated with slurry prior to curing and sintering so that conductive metal particles are sintered to the meshes and also at the contact points to the metal plate.

The resulting first electrode assembly 30 is shown in FIG. 2F. This first electrode assembly is used, as will now be described, as the starting point to form a bipolar plate with first and second electrode assemblies on opposite sides thereof.

The way this is done will now be explained with reference to the further FIGS. 2G to 2L. First the first electrode assembly shown in FIG. 2F is inverted as shown in FIG. 2G. Then the steps shown in FIGS. 2B to 2D are repeated, generally using a new mould 10 fractionally larger (or smaller) than the previous mould 10 using a new layer of slurry 14, a new mesh 20 and a new mesh 36. The point of using a new larger or smaller mould 10 (not shown) is to ensure the electrode used for the anode space is fractionally larger than that used for the cathode space so that it can press the anionic exchange membrane 46 against the recessed square seat of the holder 56 discussed below with reference to FIGS. 3A to 3E. Then, as shown in FIG. 2K the inverted electrode assembly of FIG. 2G is placed on top of the upper knuckles of the second mesh 36. Again the side walls of the mould control the thickness of the electrode assembly below the metal plate 26 forming the bipolar plate 44. After curing of the binder medium the electrode assembly, i.e. the bipolar plate 44 with first and second porous electrodes 30 on either side is removed from the mould and fully cured and sintered as described above to result in the bipolar plate 44 of FIG. 2L.

Instead of using the first electrode assembly 30 of FIG. 2F for the construction of the bipoplar plate, the first electrode assembly 30 of FIG. 1E could be used. Moreover, it is not essential that a second mesh 36 is used in the step of FIG. 2J. That step could be omitted. This is also the case when the first electrode assembly 30 of FIG. 2F is used. Thus it is not essential that the electrode structure at the anode and cathode sides of the bipolar plate are identical. In particular as there is a flow of conductive medium or electrolyte through the anode spaces a higher flow area for lateral flow is important there. In the anode spaces there is basically only a lateral flow of hydrogen gas that is generated in the moist environment, so that only a smaller flow area for lateral flow is required there.

In the following the formation of an electrolyser stack 48 will now be described with reference to FIG. 2M.

Starting from the bottom a first metallic plate 50 is provided which can, for example, as shown here, be the anode connection for the stack. On top of this there is placed a first electrode assembly 30 in accordance with FIG. 2G (or a first electrode assembly 30 in accordance with FIG. 1E-not shown here) and then a sheet of an anionic exchange membrane 46 is placed on the free-standing planar surface of the porous layer 32. Next a bipolar plate 44 in accordance with FIG. 2L, with electrode assemblies 30, on opposite sides thereof, is placed on the anionic membrane 46. A further anionic membrane is then placed on the freestanding planar surface of the electrode assembly on the bipolar plate. The process described immediately above is then repeated for any desired number of bipolar plates in accordance with FIG. 2L. Only two such bipolar plates are shown here for the sake of simplicity.

Thereafter a final anionic exchange membrane is placed on the freestanding surface of the uppermost electrode of the bipolar plate and a further first electrode assembly, e.g. in accordance with FIG. 2F (or FIG. 1E-not shown) is added. Finally a second metallic plate 50, which can be the cathode connection to the stack, is added and the stack pressed together by forces acting in the direction of the arrows. These forces can be generated by clamping bolts or by spring pressure or by mechanical pressure or otherwise. The clamping bolts or other clamping means (not shown) can either be arranged externally of the stack 86 of FIG. 4A as described below, or can pass in FIG. 4A through the end plates 50, the end electrodes 26, the holders 56 in areas outside of the anode and cathode spaces 52, 54 and through the bipolar plates 44 and the central connection plate 94.

Thus the resultant stack has anode spaces 52 and cathode spaces 54 on opposite sides of each anionic membrane 46.

In practise the electrode assembles of the stack are not just arranged one above the other but are instead arranged in special holders 56 which will now be described with reference to FIGS. 3A to 3E. The insulating holders may be made of a plastic such as polyamide and may be formed by injection molding or machining. For the sake of simplicity the electrodes for the cathode and anode spaces have been drawn to the same size in FIG. 2M. However, it will be appreciated that the electrodes in the anode spaces 52 are actually fractionally larger than the electrodes in the cathode spaces 54 so that the electrodes in the anode spaces 52 can press the anionic exchange membranes 46, which are of the same width and length as the electrodes for the anode spaces 52, against the square seats 78 provide in and around the square openings 58 in the holders 56.

In a practical example, which is in no way to be taken as a restriction on the size of the electrolyser cells, the square opening 58 in the holder 56 is 160 mm in width and length, the holder 56 is 350 mm in diameter and has an axial depth of 6 mm which equates to the depth of a cathode space plus the depth of the anode space, which is typically the same as the depth of the cathode space, but not necessarily the same. The thickness of the anionic exchange membrane is typically about 100 microns and can be ignored as the porous electrode assemblies in the anode and cathode spaces can be compressed by this amount on pressing the cells of the electrolyser stack together. The width of the recessed seat 78 is 10 mm on each side of the square opening 58.

FIG. 3A shows a plan view of the anode side, the A-side, of the holder 56. As can be seen the holder 56 is circular in shape and has the square central opening 58. Below the square opening there is transverse feed groove 60 which communicates via a plurality of short feed passages 62 with the anode space of an electrode (not shown but which would be arranged in the square opening 58 at the larger side adjacent the square seat 78). The bottommost transverse groove 60 communicates with a feed passage 64 for electrolyte extending axially through the holder 56. Above the square opening 58 there is a symmetrically designed arrangement of a transverse outlet groove 66 which also communicates with the anode space 52 of an electrode in the square opening 58 via short outlet passages 68 and which leads to an outlet passage 70 for electrolyte extending axially through the holder 56. The reference numeral 72 indicates a circumferential groove sized to receive an O-ring 72′ and reference numerals 74 and 76 show further grooves for O-rings surrounding the feed passage 64 and the outlet passage 70 respectively. Around the square opening 58 there is a square recessed seat 78 at about half the axial height of the holder 56, as can be seen from FIG. 3D.

In use the holder 56 is placed onto a first electrode assembly 30 so that the freestanding porous surface lies at the level of the square seat 78. A square sheet of anionic membrane placed on the freestanding porous surface and is pressed against the square recessed seat 78. The cathode side of a bipolar plate 44 is then placed so that its planar porous surface lies on the anionic membrane. At the cathode side of each holder 56 there are transverse grooves 82 and axial passages 84 for collecting hydrogen generated in the cathode spaces 54.

The bipolar plate 44 has the same circular shape and size as the holder 56 and engages against the upper side of the holder 56 in this example. It is sealed there by an O-ring 80′ inserted into an O-ring groove 80 shown at the cathode side of the holder 56 as seen in FIG. 3B. It will be noted that the two O-ring grooves 72 and 80 are concentric but radially offset so that the holder 56 is not unduly weakened by them. The bipolar plate 44 also seals against the anode side of the next holder 56 at an O-ring 72′ provided in the groove 72. Thus each holder 56 houses the anode and cathode spaces 52, 54 of one cell of a stack and each holder 56 is arranged either between a conductive metal plate 26 of a first electrodes and a bipolar plate 44, or between two consecutive bipolar plates 44.

Holes or bores (not shown here but in FIG. 4A) are provided in the electrode plates 26 and bipolar plates 44 which respectively align with the main feed passage 64 for the supply of electrolyte to the anode space, with the main outlet passages 70 for removing electrolyte and oxygen from the anode spaces and with the axial passages 84 for removing hydrogen from the cathode spaces 54 Corresponding holes are provided in at least one of the end plates for the feed of electrolyte into the main feed passages 54, for the removal of electrolyte and oxygen from the main outlet passages and for the removal of hydrogen from the axial passages 84.

Turning now to FIGS. 4A and B there can be seen a schematic illustration of an electrolyser stack 86, here arranged horizontally, with end plates 50, end-electrodes 30, bipolar plates 44 and electrode holders 56 containing porous anodes, porous cathodes and anionic membranes 46.

At the centre of the stack 86 there is a connection plate 94 which acts in this embodiment as a monopolar cathode plate having electrode structures on both sides. The electrode structures cannot be seen completely in FIGS. 4A and B as the porous elements and anionic membranes 46 located within the holders 56 are not shown for the sake of simplicity. Only the conductive non-porous metal plates 26 of the electrodes 30 and the central connection plate 94 (here a cathode) are shown in FIG. 4. The central connection plate 94 does not have to be as thick as an end plate 50 as shown but could be thinner and indeed could be just as thick as a regular bipolar plate providing an electrical connection can be made to it.

The horizontal arrangement is preferred since the anode spaces 52 are then arranged vertically, as shown in FIG. 4A and thus O₂ generated in the anode spaces can rise to the top of the anode spaces due to gravity and buoyancy effects and the oxygen is efficiently removed from the anode spaces 52 and the stack 86.

It can also be seen from FIG. 4A that the holders 56 and the bipolar plates 44 and thus the electrodes are arranged vertically. This is the preferred arrangement because the flow of electrolyte laterally through the mesh(es) 30, 36 in the plane of the meshes, i.e. of the weave, takes place vertically upwardly in the anode spaces 52 and thus gravity and the resulting buoyancy drives the oxygen upwardly through each anode space 52 to the outlet manifold.

It should be noted that the cells on the right side of the central connection plate 94 are arranged the other way around from the cells on the left side of connection plate 94. Put another way, the cathode and anode spaces 54, 52 are reversed, i.e. mirror symmetry is present on the two sides of the central connection plate 94, which thus has porous cathodes on both sides.

It should also be noted that electrolyte, e.g. purified water containing KOH ions, flows through the anode spaces 52 of all the cells but the cells to the right of the central cathode 92 are arranged the other way around from the cells to the left of the central cathode 92 to reflect the opposite direction of the electric field.

This means that either two different types of holders with mirror symmetry have to be provided at the two sides of the central plate 94, or a symmetrical design of holder 56 has to be chosen which can be used either way around. This could be done, for example, by moving the inlet bore or main feed passage 64 along the transverse feed groove 60 to a central six o'clock position in FIG. 3A and by moving the main outlet passage or outlet bore 70 along the outlet groove 66 to a central twelve o'clock position in FIG. 3A.

Alternatively, the holders 56 could be provided with extra bores to ensure the flow of electrolyte through all anode spaces 52 irrespective of which way round the holders are used on the two sides of the central connection plate 94.

In the illustrated embodiment there are thus twelve holders 56 each surrounding an electrolyser cell having an anode space and a cathode space with an anionic exchange membrane disposed between them as described in connection with FIG. 2M. There is no specific limit on the number of holders 56, i.e. of electrolyser cells in the stack 86 and there could be more or fewer than shown, but always the same number of holders and cells on both sides of the central connection plate.

An electrolyser needs a DC power source of some kind and in the present embodiment this is formed by a photovoltaic panel 90 on which sunlight indicated by arrows 92 falls. The solar panel in this embodiment has a maximum outlet voltage of 12V. The positive side of the power supply is connected to the left hand end plate 50 and to the right hand end plate 50, which thus form anodes. The negative side of the power supply is connected to the central connection plate 94 which is thus the central cathode. This arrangement has the result that the electrolyser cells to the right and left of the central plate 94 are connected electrically in parallel so that the maximum outlet potential of 12V (in this case) acts across two groups of six cells. I.e there is a potential drop of a maximum of 2V across each electrolyser cell (depending on the intensity of the incident sunlight) No power is provided to the bipolar plates 44, instead these adopt a floating potential due to the electric field in which they are located between the central cathode 94 and each of the end anodes, 26, 50, so that the desired potential drop in the range from 1.8 to 2 volts arises across each cell. Each bipolar plate 44 acts as an anode for one cell and as a cathode for the adjacent cell, hence the name bipolar plate.

This arrangement not only leads to higher electric fields in the electrolyser but also minimizes the energy loss due to an external magnetic field. These two factors greatly enhance the performance of the stack.

There is no restriction on the outlet power of the photovoltaic panels and the stack is basically self-regulating in the sense that the electrolyser will convert all power received from the solar panels into hydrogen and oxygen, irrespective of whether the solar panel(s) is or are generating the maximum power or a lesser amount if the light intensity is less than the design maximum, which will frequently be the case. Naturally the electrolyser must be sized to exploit the maximum amount of power from the solar panel(s) and will simply generate less hydrogen and oxygen as the power delivered reduces. A pump 106 is provided for pumping electrolyte through the anode spaces 52 and can also be driven from the power received from the solar panel(s) as can all other electrical components associated with the stack 86. The pump 106 draws the electrolyte comprising distilled water containing KOH ions from a container 108 via tube 110 which extends almost to the bottom of the container 108 The pump delivers the electrolyte via a feed line 112 which feeds the electrolyte into an inlet 114 and into the inlet passages 64 which extend right the way through the bottom of the stack 86 including through the end plates 50, the electrodes 26, the insulating holders 56 and the bipolar plates 44 as well as through the central connection plate 94.

At the lower right hand side of the stack the bore 64 through the end plate 50 is closed by a plug 118. This allows the pressure delivered by the pump 106 to pump the electrolyte vertically upwardly through all the anode spaces 52 and the porous structures provided there to the aligned outlets passages 70. The aligned outlet passages 70 again form part of a continuous bore extending through the endplates 50, the electrodes 26, the insulating holders 56, the central connection plate 94 and the bipolar plates 44 to an outlet at the top right hand side of end plate 50 and into a return line 120. The anode spaces 52 are thus all connected in parallel for the flow of electrolyte.

Return line 120 returns the mixture of electrolyte and oxygen leaving the stack to the sealed container 108, where the mixture separates via gravity into electrolyte at the bottom of the sealed container 108 and oxygen at the top of the container 108. The oxygen could be drawn off from the container 108 via a line 121 by a pump 124 which feeds the oxygen through a line 125 into a collector 126 shown here schematically as a gas bottle.

However, this is not the preferred arrangement, since it is very difficult to compress oxygen as the slightest trace of fat, for example from a person's fingers, can lead to a horrific explosion. In fact most electrolysers simply dump the oxygen into the atmosphere and do not seek to collect it. This is also possible here. Another alternative would be to provide a non-return valve, also schematically indicated here by the reference numeral 124 (which is now no longer a pump). The non-return valve 124 allows the collector 125 to be filled to a pressure set by the non-return valve. However, as stated it is simpler and cheaper to discharge the oxygen into the atmosphere.

The continuous bore 70 extending through the end plates 50, the electrodes 26, the holders and the bipolar plates 44 as well as through the central connection plate 94 is closed at the upper end of the left hand end plate 50 by another plug 118.

The design just described means that the end plates 50, the central plate 94, the electrodes 26 and the bipolar plates and the holders 56 can all have the same hole pattern with respect to the anode spaces 52.

The hydrogen generated in the cathode spaces 54 passes through the aligned outlet passages 84. These are again parts of continuous bores extending through the end plates 50, the electrodes 26, the holders 56, the bipolar plates 44 and the central electrode 94. Because these two continuous bores are outside of the section plane of FIG. 4A as illustrated at A-A in FIG. 4B, and are arranged behind one another in this drawing, they are only shown as broken lines representing the aligned outlet passages 84 in the holders 56. It will be appreciated that the left hand ends of these passages are also closed by plugs such as 118. The outlet ends are connected to a line 127 leading to a pump 128 for hydrogen which feeds the hydrogen via a line 129 into a collector 130, again schematically illustrated as a gas bottle.

The use of a pump 128 for the hydrogen is possible but not actually preferred, since pumps can leak and also require input power to operate. A much more favoured design is to replace the pump 128 by a non-return valve, also represented by the reference numeral 128, which now is no longer a pump. The non-return valve 128 controls the pressure to which the hydrogen collector can be filled. Of course such a design means that the pressure in the cathode spaces 54 can increase up to the design pressure of the gas collector 130. However, this is entirely possible. One advantage of the stack of FIG. 4 with relatively small areas of the electrodes is that it can readily run at high pressures without having to use unnecessarily massive clamping bolts and without having to fear failure of the anionic membranes.

Again the hole patterns in the end plates 50, the electrodes 26, the holders 56, the bipolar plates 44 and the central connection plate 94 are all the same and symmetrically disposed. As a result the components can be made very cost effectively. The end plates 50 and the central connection plate 94 can be identical. The bipolar plates 44 can also all be identical, as can the electrodes 26 and the holders 56. This design assumes the inlet and outlet bores 64 and 70 for the anode spaces are symmetrically placed as indicated in FIGS. 4A and B as discussed above.

As the electrolyte is progressively converted into oxygen and hydrogen the level of electrolyte in the sealed container 108 falls progressively and needs to be topped up from a reservoir 134 via a metering valve 132. If required a pump (not shown) may be needed for this, depending on the pressure prevailing in the sealed container 108. Also it is necessary to periodically check the KOH concentration within the electrolyte because H₂O gets lost as a main part of the electrolysis process.

As stated above the electrode of the present invention can also be used in fuel cells, in accumulators and in catalytic converters.

It will be appreciated that a fuel cells come in various forms. There are for example gas/gas fuel cells, liquid/gas fuel cells and liquid/liquid fuel cells as well as solid oxide fuel cells. Typical gas/gas fuel cells operate with hydrogen or a synthetic hydrogen rich gas as one gas and oxygen or atmospheric air as the other gas. Fuel cells of this kind can be realised using electrodes in accordance with the present teaching.

Basically the fine porous layer 32 of the cathode space 54 is coated with a catalyst, typically a noble metal such as platinum, and the fine porous layer 32 of the anode space 52 is also coated with a catalyst, again typically platinum. The electrodes in a fuel cell are not based on nickel as in an electrolyser cell but can be another suitable metal such as stainless steel. Instead of an anionic exchange membrane a proton exchange membrane is used.

In operation hydrogen or a hydrogen rich synthetic gas is supplied to the anode space and is split at the catalyst into positive hydrogen ions and negatively charged electrons. The negatively charged electrons flow through the porous layer and the adjacent layer(s) of wire mesh 20, 36 to the anode plate 26 and via an external circuit, for example an electric motor (not shown), to the corresponding cathode plate 26 or bipolar plate 44. H they react with the oxygen molecules and the positively charged hydrogen ions that have diffused through the proton exchange membrane to form water molecules that are discharged from the cathode space 54. Thus, in comparison to an electrolyser, liquid, i.e. water, is discharged from the cathode space 54 rather than from the anode space 52 and the hydrogen gas is supplied to the anode space 52 rather than being discharged from the cathode space. Thus, the holders 56 of FIGS. 3 and 4 are arranged the other way round, or, put another way, the cathode and anode spaces 54, 52 are reversed. The use of one or more wire mesh layer(s) in the cathode and anode spaces 54, 52 of a fuel cell based on the electrode design of the present invention, with fused electrical connections between the porous layers 32, the mesh layer(s) 20, 36 and the non-porous electrode plates 26, 44, is particularly beneficial. It leads to excellent flow of the gases through the respective cathode and anode spaces 54 and 52 and to homogenous power generation per unit area of the fuel cells, as well as to a low and highly uniform electrical resistance in the fuel cell.

In the same way as for an electrolyser, a plurality of fuel cells are usually combined into a fuel cell stack. Also a design with a central electrode as in FIG. 4 is advantageous in a fuel cell stack.

An example of a liquid/gas fuel cell is a so-called direct methanol fuel cell. In a fuel cell of this kind methanol and water, diluted methanol, is fed to the anode space 52 of the fuel cell and the carbon dioxide that is generated there is discharged from the anode space 52. Again hydrogen atoms are split into protons and electrons. As before, in the hydrogen/oxygen fuel cell, the protons, the positively charged hydrogen ions, diffuse through the proton exchange membrane to the cathode space 54 and the electrons pass through the conductive material of the anode space 52 to the electrode plate (anode) 26, 44 and via an external circuit to the cathode. Oxygen or air is fed to the cathode space and the returning electrons react there with the protons and oxygen to form water which is discharged from the cathode space. Although the direct methanol fuel cell, or a direct ethanol fuel cell which operates in the same way, lead to the generation of some carbon dioxide, this is not so problematic. Indeed the carbon dioxide can be bubbled through water in the presence of a special copper catalyst to form ethanol. Research on such copper catalysts based on Cu₇ is well advanced.

Basically the direct methanol fuel cell based on the present invention is very similar to the hydrogen//oxygen fuel cell described above and the same catalysts are used.

It is only necessary to modify the holders that are used to permit the discharge of carbon dioxide from the anode space and water from the cathode space.

In fact there is a huge class of liquid fuel cells based on the most diverse organic liquids which can also be used with electrodes designed in accordance with the present invention. A discussion of such liquid fuel cells can be found in the article “Liquid Fuel Cells” by Gregori L. Soloviechik of General Electric Global Research, Niskayuna, NY 12309 USA in the Journal of Nanotechnology 2014, 5, 1399 to 1418 published on Aug. 24, 2014.

As mentioned above some fuel cells use hydrogen rich synthetic gas as a fuel and that gas is frequently formed by a so-called reformer from a fuel such as diesel. The structure of a reformer is very similar to that of a fuel cell and the electrodes of the present invention can also be used in reformers.

As mentioned above the electrodes of the present invention can also be used in rechargeable batteries. In a typical battery there is a positive electrode separated from a negative electrode by a separator filled with an electrolyte. During the discharge of the battery electrons flow from the positive electrode, the anode, to the negative electrode, the cathode, through an external circuit. Positively charged ions migrate through the electrolyte and the separator to the negative electrode where they react with electrons returning from the external circuit and are neutralised. Once the battery is discharged an external electrical power source is used to reverse the direction of flow of electrons and ions and recharge the battery. It will be appreciated that the electrodes in accordance with the present invention can be used as anodes and cathodes of a rechargeable battery. It is simply necessary to select the chemistry of the anode and cathode appropriately and to use a suitable electrolyte and separator.

### LIST OF REFERENCE NUMERALS

10 mould
12 internal base surface of mould
14 layer of slurry
16 particles
18 binder medium
20 (first) layer of electrically conductive mesh, contacts porous layer 32
22 lower knuckles of mesh 20
24 upper knuckles of mesh 20
26 conductive non-porous metal plate
28 side walls of mould 10
30 finished assembly (electrode or catalyst carrier)
32 porous layer
34 first mesh passages
36 (second) layer of electrically conductive mesh, contacts metal plate 26
38 second mesh passages
40 lower knuckles of electrically conductive mesh 36
42 upper knuckles of electrically conductive mesh 36
44 bipolar plate
46 anionic exchange membrane
48 electrode stack of an electrolyser
50 conductive plate, anode or cathode connection to a stack
52 anode space
54 cathode space
56 insulating holder,
58 square opening
60 transverse feed groove for an anode space 52
62 short feed passages for an anode space 52
64 main feed passage for the anode spaces 52
66 outlet groove for electrolyte and oxygen leaving an anode space
68 outlet passages for electrolyte and oxygen leaving an anode space
70 main outlet passage for electrolyte and oxygen leaving an anode space
72 O-ring groove
72 O-ring
74 O-ring groove
76 O-ring groove
78 recessed square seat for anionic membrane
80 O-ring groove
80 O-ring
82 transverse grooves communicating with cathode spaces 54
84 axial passages communicating with transverse grooves 82 for removing
hydrogen from the cathode spaces
86 electrolyser stack
88 O-ring groove
90 photovoltaic panel
92 sunlight incident on panel 90
94 non porous conductive central connection plate
96 O-ring grooves at anode side
96′ O-rings
98 O-ring grooves at cathode side
98′ O-rings
106 pump for electrolyte
108 container for supply of electrolyte
110 tube
112 feed line for electrolyte
114 inlet passage for electrolyte
116 outlet passage for electrolyte and O₂
118 plugs
120 return line for electrolyte and O₂ to container
121 line for extracting oxygen from container 108
124 pump for pumping O₂ into collector 126, or, alternatively, a non-return valve
125 line to oxygen collector 126
126 collector for O₂
127 hydrogen outlet line
128 pump for H₂, 126, or, alternatively, a non-return valve
129 line for H₂
130 collector for H₂
132 metering valve for topping up electrolyte in container 108
134 reservoir for supply of electrolyte to container 108

1-31. (canceled)

32. An electrode including at least an electrically conductive plate, at least one layer of an electrically conductive mesh having knuckles in electrical contact with the electrically conductive plate and mesh passages for the flow of an electrically conductive medium laterally through the mesh, as well as a porous layer of electrically conductive material coating a surface of the at least one layer of electrically conductive mesh remote from the conductive plate, in fused electrical contact therewith and having a planar surface remote from the electrically conductive plate, a pore size of the porous layer being substantially smaller than a pore size of said mesh passages.

33. The electrode in accordance with claim 32, wherein said at least one layer of an electrically conductive mesh comprises first and second layers of an electrically conductive mesh the first layer being in electrical contact with the porous layer and having first mesh passages and the second layer of an electrically conductive mesh having second mesh passages larger than said first mesh passages, the second layer being in electrical contact with said porous layer.

34. The electrode in accordance with claim 32, wherein said porous layer is a layer of particles sintered together and to knuckles remote from said conductive plate.

35. The electrode in accordance with claim 32, wherein said at least one layer of mesh is sintered to particles of said porous layer and to said metal plate optionally via a second layer of mesh.

36. The electrode in accordance with claim 32, wherein the at least one layer of mesh is coated with sintered particles.

37. The electrode in accordance with claim 32, wherein the porous layer comprises metal particles having sizes in the range from <0.1 microns to 10 microns, whereby the interstitial spaces or pores between the sintered particles have sizes approximately one tenth of those of the particles used.

38. The electrode in accordance with claim 32, wherein said mesh passages of said at least one layer of nesh have pore sizes for lateral flow through the mesh in the range from 20 microns to 2 mm.

39. The electrode in accordance with claim 32, wherein said first layer of mesh adjacent the porous layer has mesh passages has pore sizes for lateral flow through the mesh smaller than those of the layer of mesh adjacent the metal plate, the pore sizes of the layer of mesh adjacent the porous layer having pore sizes for lateral flow through the mesh in the range from 20 microns to 2 mm and the second layer of mesh has pore sizes for the lateral flow of medium through the mesh greater than those of said first layer of mesh.

40. The electrode in accordance with claim 32, wherein a surface of said electrically conductive plate remote from said at least one layer is in fused electrical contact with knuckles of at least one further layer of electrically conductive mesh having mesh passages, said at least one further layer of mesh being a single layer or first and second layers of mesh and knuckles of said at least one further layer remote from said electrically conductive plate, being in fused electrical contact with a porous layer of electrically conductive material coating a surface of the at least one further layer remote from the conductive plate, being in fused electrical contact therewith and having a planar surface remote from aid electrically conductive plate.

41. The electrode in accordance with claim 32, wherein any said layer of mesh comprises one of a woven wire mesh, a knitted wire mesh and an expanded metal grid.

42. The electrode in accordance with claim 32, wherein said conductive plate any said layer of mesh and said electrically conductive particles comprise any one of nickel, copper, gold, carbon or platinum.

43. The electrode in accordance with claim 32 wherein the electrical contacts between components of the electrodes are sintered contacts.

44. An electrode having at least the following components, at least an electrically conductive plate, at least one layer of an electrically conductive mesh having first knuckles in electrical contact with the electrically conductive plate, mesh passages for the flow of an electrically conductive medium laterally through the mesh and second knuckles at an opposite side of said mesh from said first knuckles, as well as a porous layer of electrically conductive particles coating surfaces of the at least one layer of electrically conductive mesh, said components forming a sintered together body with fused electrical connections between all said components and the porous layer having a planar surface remote from the electrically conductive plate, a pore size of the porous layer being substantially smaller than a pore size of said mesh passages.

45. The electrode in accordance with claim 44, there being first and second layers of mesh, each having respective mesh passages and first and second knuckles at opposite sides of the respective layer, the second layer being disposed between the first layer and the conductive plate, the second knuckles of the second layer being sintered to the electrically conductive plate, the first knuckles of the second layer being sintered to adjacent knuckles of the first layer of mesh and the first knuckles of the first layer of mesh being sintered to particles of the porous layer, the mesh passages of the second layer having a pore size greater than those of the first layer.

46. The electrode in accordance with claim 44, wherein a surface of said electrically conductive plate remote from said at least one layer is in fused electrical contact with knuckles of at least one further layer of electrically conductive mesh having mesh passages, said at least one further layer of mesh being a single layer or first and second layers of mesh and knuckles of said at least one further layer remote from said electrically conductive plate, being in fused electrical contact with a porous layer of electrically conductive material coating a surface of the at least one further layer remote from the conductive plate and having a planar surface remote from aid electrically conductive plate, the electrode being a sintered together body.

47. The electrode in accordance with claim 44, wherein each said layer of mesh is a woven wire mesh or a knitted wire mesh.

48. The electrode in accordance with claim 44, in which all components comprise nickel.

49. An electrode stack, the stack including first and second end electrodes, which may be end plates, at respective opposite ends of the stack, for connection to one terminal of a power supply, an even number of cells disposed between the first and second end electrodes, each cell comprising a porous anode and a porous cathode with an anionic membrane between them, bipolar plates each disposed between two directly adjacent cells and a central connection plate for connection to a second terminal of the power supply with an equal number of cells on each side of the central connection plate.

50. The electrode stack in accordance with claim 49, wherein the stack has a symmetrical design on each side of the central connection plate, i.e. the cells on one side of the central connection plate have mirror symmetry to the cells on the other side of the central connection plate, so that on each side of the central connection plate and directly adjacent to it there are either anode spaces or cathode spaces.

51. The electrode stack in accordance with claim 49, wherein the anodes and cathodes of each cell comprise electrodes having at least the following components, at least an electrically conductive plate, at least one layer of an electrically conductive mesh having first knuckles in electrical contact with the electrically conductive plate, mesh passages for the flow of an electrically conductive medium laterally through the mesh and second knuckles at an opposite side of said mesh from said first knuckles, as well as a porous layer of electrically conductive particles coating surfaces of the at least one layer of electrically conductive mesh, said components forming a sintered together body with fused electrical connections between all said components and the porous layer having a planar surface remote from the electrically conductive plate, a pore size of the porous layer being substantially smaller than a pore size of said mesh passages.

52. The electrode stack in accordance with claim 49, wherein the stack is arranged substantially horizontally with the cells.

53. The electrode stack in accordance with claim 49 and having insulating holders for each cell, each holder having an opening defining an anode space containing a porous anode, a cathode space containing a porous cathode and optionally a seat for an anionic membrane, the anionic membrane being disposed between and contacting the porous anode and the porous cathode, wherein a feed passage for electrolyte extends through the stack passing through at least one end electrode, through the holders, through the bipolar plates and through the central connection plate and communicates within the holders with the anode spaces to feed electrolyte to all anode spaces of the stack in parallel, wherein an outlet passage for electrolyte and oxygen extends through the stack passing through at least one end electrode, through the holders, through the bipolar plates and through the central connection plate and communicates within the holders with the anode spaces to extract electrolyte and oxygen from the anode spaces, wherein an outlet passage for hydrogen passes through at least one end electrode, through the holders, through the bipolar plates and through the central connection plate and communicates within the holders with the cathode spaces to extract hydrogen from the cathode spaces, and wherein the feed passage for electrolyte is disposed towards the bottom of the stack and the outlet passage for electrolyte and oxygen is disposed towards the top of the stack higher than the feed passage for electrolyte.

54. An electrode stack comprising a first electrode including at least an electrically conductive plate, at least one layer of an electrically conductive mesh having knuckles in electrical contact with the electrically conductive plate and mesh passages for the flow of an electrically conductive medium laterally through the mesh, as well as a porous layer of electrically conductive material coating a surface of the at least one layer of electrically conductive mesh remote from the conductive plate, in fused electrical contact therewith and having a planar surface remote from the electrically conductive plate, a pore size of the porous layer being substantially smaller than a pore size of said mesh passages, a plurality of electrodes including at least an electrically conductive plate, at least one layer of an electrically conductive mesh having knuckles in electrical contact with the electrically conductive plate and mesh passages for the flow of an electrically conductive medium laterally through the mesh, as well as a porous layer of electrically conductive material coating a surface of the at least one layer of electrically conductive mesh remote from the conductive plate, in fused electrical contact therewith and having a planar surface remote from the electrically conductive plate, a pore size of the porous layer being substantially smaller than a pore size of said mesh passages, wherein a surface of said electrically conductive plate remote from said at least one layer is in fused electrical contact with knuckles of at least one further layer of electrically conductive mesh having mesh passages, said at least one further layer of mesh being a single layer or first and second layers of mesh and knuckles of said at least one further layer remote from said electrically conductive plate, being in fused electrical contact with a porous layer of electrically conductive material coating a surface of the at least one further layer remote from the conductive plate, being in fused electrical contact therewith and having a planar surface remote from aid electrically conductive plate and a further electrode including at least an electrically conductive plate, at least one layer of an electrically conductive mesh having knuckles in electrical contact with the electrically conductive plate and mesh passages for the flow of an electrically conductive medium laterally through the mesh, as well as a porous layer of electrically conductive material coating a surface of the at least one layer of electrically conductive mesh remote from the conductive plate, in fused electrical contact therewith and having a planar surface remote from the electrically conductive plate, a pore size of the porous layer being substantially smaller than a pore size of said mesh passages, said electrodes being disposed to generate pairs of confronting planar surfaces of porous material, there being an anionic exchange membrane disposed between each pair of confronting planar surfaces, there being hydraulic, pneumatic or spring means for pressing the electrodes of the stack and the interposed anionic exchange membranes together.

55. The stack in accordance with claim 54, wherein first passages are provided for supplying a conductive liquid formed by water with an alkaline metal hydroxide such as KOH to anode spaces at an anode side of each anionic exchange membrane and second passages for extracting the conductive liquid with oxygen from the anode spaces, there being at least one third flow passage for extracting hydrogen from cathode spaces at a cathode side of each anionic exchange membrane.

56. The stack in accordance with claim 55, wherein the conductive meshes of the electrodes and the porous layers of the stack are square or rectangular in plan view and are disposed within insulating holders forming manifolds for the anode and cathode spaces, there being seals between adjacent holders and the confronting conductive metal plates.

57. The stack in accordance with claim 54, wherein conductive plates at each end of the stack are respectively connectable to one of an anode and cathode of a power supply, or wherein the two conductive plates at each end of the stack are both connectable to one of an anode and a cathode of the power supply and a centre electrode of the stack is connected to the other of said anode or cathode.

58. The stack in accordance with claim 57, wherein the holders and the conductive plates are circular or polygonal in plan view.

59. A method of forming an electrode including at least an electrically conductive plate, at least one layer of an electrically conductive mesh having knuckles in electrical contact with the electrically conductive plate and mesh passages for the flow of an electrically conductive medium laterally through the mesh, as well as a porous layer of electrically conductive material coating a surface of the at least one layer of electrically conductive mesh remote from the conductive plate, in fused electrical contact therewith and having a planar surface remote from the electrically conductive plate, a pore size of the porous layer being substantially smaller than a pore size of said mesh passages including the steps of;
a) introducing a slurry of particles in a hardenable and reducible binder medium into a mould having a planar base surface,
b) placing a layer of an electrically conductive mesh having knuckles onto the layer of slurry and coating the knuckles with said slurry,
c) placing a metal plate onto knuckles of said mesh remote from said slurry,
d) partially hardening or fully hardening said binder medium prior to or after step c) and
e) heating the electrode in a reducing atmosphere to remove the binder medium and sinter the electrode assembly together.

60. The method in accordance with claim 59 for forming an electrode including at least an electrically conductive plate, at least one layer of an electrically conductive mesh having knuckles in electrical contact with the electrically conductive plate and mesh passages for the flow of an electrically conductive medium laterally through the mesh, as well as a porous layer of electrically conductive material coating a surface of the at least one layer of electrically conductive mesh remote from the conductive plate, in fused electrical contact therewith and having a planar surface remote from the electrically conductive plate, a pore size of the porous layer being substantially smaller than a pore size of said mesh passages, wherein said at least one layer of an electrically conductive mesh comprises first and second layers of an electrically conductive mesh the first layer being in electrical contact with the porous layer and having first mesh passages and the second layer of an electrically conductive mesh having second mesh passages larger than said first mesh passages, the second layer being in electrical contact with said porous layer, and comprising the further steps of;
g) repeating the steps a), b) c) and d),
h) inverting the resulting electrode assembly
i) repeating the steps and a) and b), optionally using a second mould larger than the first,
j) placing the inverted electrode assembly of step h) on the assembly resulting from the repeated steps a) and b) and carrying out or repeating the steps d) and e).

61. The method in accordance with claim 59 and comprising the further steps of;
k) inserting a second layer of mesh onto the conductive layer of mesh of step b) and or inserting a second layer of mesh onto the assembly after repeating the step b).

62. A method in accordance with claim 55 and comprising the further steps of arranging a plurality of electrodes in accordance with claim 55 between first and second electrodes so that confronting pairs of planar surfaces are formed and placing an ionic exchange membrane between each pair of confronting planar surfaces, and l) compressing the plurality of electrodes together to form a stack.

63. The electrode in accordance with claim 32, wherein said porous layer of electrically conductive particles coats surfaces of the at least one layer of electrically conductive mesh and of said second knuckles remote from the conductive plate.
